(19) United States
(12) Patent Application Publication
(10) Pub. No.: US 2006/0271923 A1
(43) Pub. Date: Nov. 30, 2006

(54) Methods and apparatus for categorizing computer system states for use in identifying individual computer systems to receive state-dependent maintenance

(75) Inventors: David F. Bantz, Portland, ME (US); Steven J. Mastrianni, Unionville, CT (US); Clifford A. Pickover, Yorktown Heights, NY (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 11/138,871

(22) Filed: May 25, 2005

(51) Int. Cl. G06F 9/44

(52) U.S. Cl. 717/168

(57) ABSTRACT

The present invention concerns methods and apparatus that categorize states of computer systems selected to receive state-dependent maintenance activities as a prelude to the performance of those maintenance activities. In methods and apparatus of the present invention, it is determined, for example, that a certain version of an application program operating in computer systems having a specific operating system will be updated. A signature corresponding to the combination of the application program and operating system is incorporated in a software agent. The software agent is designed to poll computer systems in order to identify targets drawn from a population of computer systems that have states corresponding to the signature incorporated in the software agent. All computer systems having states that correspond to the signature then have the state-dependent computer maintenance activity performed on them.

### TECHNICAL FIELD

The present invention generally concerns methods and apparatus for performing maintenance activities on multiple computer systems, and more specifically concerns methods and apparatus for performing maintenance activities where the nature of the maintenance activities depends on initial states of individual computer systems, and where the methods and apparatus of the present invention identify and categorize initial states of individual computer systems so that maintenance activities appropriate to each computer system can be performed.

### BACKGROUND

Computers—like most complex systems—require periodic maintenance. Similar to other complex systems, the nature of a maintenance action to be performed on an individual computer system often depends on the current configuration of the computer. For example, computers running one type of operating system may have file backup actions performed on them in a way that is significantly different from those running a different operating system. In fact, maintenance actions may differ dependent on what version of a particular operating system is installed on a computer.

The nature of maintenance to be performed on an individual computer is often selected by examining a boot disk image to determine the system configuration of the computer. Examination of the boot disk image will provide information concerning the operating system installed on the computer; the update status of the operating system; the application programs installed, and the hardware resident on the system. From the perspective of an enterprise having multiple computer systems requiring maintenance, those computers having disk images with certain specified characteristics may be targets for a particular maintenance action, such as an update to address a security risk, while those whose disk images lack the specified characteristics may not be. As a result, in enterprise environments it is highly desirable to be able to identify those computers within a larger population of computers to which identical management actions can be applied.

In computer system maintenance methods in accord with the prior art, an enterprise may inventory their computers in a database containing information about the configurations of the inventoried computers. In addition, the database may be searchable by configuration. Maintenance activities are then scheduled in dependence on the configuration information stored in the database inventory of computer systems.

Several problems have become apparent to those skilled in the art when computer system maintenance activities are performed on a population of computers using such a method. In particular, the most significant problem encountered in such a computer maintenance program is that the inventory of computer system configurations typically does not contain accurate information. Since updates to the inventory often depend on either or both of the uninterrupted access to the inventory through a network whenever computer system maintenance is performed and the perfect diligence of technicians or end users performing computer system maintenance, neither of which occurs in practice, the inventory will not be perfectly accurate. The inventory may contain inaccurate information about certain computers, and may contain no information at all regarding other computers.

In fact, scheduling maintenance activities based on such inaccurate inventories will often lead to the shunting to the side of computer systems whose configurations do not correspond to the inventory information where it will be decided at a later date exactly what remedial maintenance (if any) should be performed on the irregular computers. It is not inconceivable that the “mop-up” associated with maintaining “irregular” computers following the spawning of a maintenance action through a population of computers whose state corresponds to their recorded state may be as burdensome as or more burdensome than the regular maintenance activity. Such a situation is especially the case when computers are mobile and occasionally disconnected. In summary, maintaining an accurate inventory database is often a difficult or impossible task.

Yet it is vital that all computers that should receive a maintenance action can be identified, especially if the maintenance action is security-related. Accordingly, those skilled in the art desire methods and apparatus for performing computer system maintenance activities that do not depend upon an accurate inventory, yet provides a means for identifying all computers that should receive a maintenance action.

Accordingly, those skilled in the art desire “on the fly” methods for identifying computer systems that should receive a maintenance action. Such methods would eliminate the waste and inefficiency associated with scheduling maintenance activities based on an inaccurate inventory of computer configurations. The decision whether to perform the maintenance action would be made as a prelude to the performance of maintenance activity; if it was determined that a particular computer did not require the maintenance action due to its configuration, the maintenance action would not be performed.

In addition, those skilled in the art desire methods and apparatus for spawning maintenance actions that eliminate the need in most instances for remedial action to be performed on computers deemed to have non-standard or irregular configurations. Such methods would preferably eliminate situations where there is disagreement between inventory information and the actual state of a computer by eliminating reference to the inventory information as part of a maintenance scheduling process. Instead, maintenance actions would be designed to handle all computer system configurations likely to exist in a target computer system population requiring maintenance activity. In such methods, the majority if not all computer systems would receive maintenance actions performed as part of a regularly-scheduled activity and not as part of a remedial action to maintain “irregular” computers.

### SUMMARY OF THE PREFERRED EMBODIMENTS

A first embodiment of the present invention comprises a method for identifying at least one programmable electronic device by configuration state, the method comprising: formulating a specification of a state-dependent action to be performed on the at least one programmable electronic device, where the specification comprises a description of an initial state configuration to be possessed by the at least one programmable electronic device; determining at least one element which describes the initial state configuration; creating a software agent to test for the presence of the at least one element which describes the initial state configuration in the at least one programmable electronic device; applying the software agent to the at least one programmable electronic device to test for the presence of the at least one element which describes the initial state configuration; and receiving a result that indicates the presence or absence of the at least one element which describes the initial state configuration.

A second embodiment of the present invention comprises a signal-bearing medium tangibly embodying a program of machine-readable instructions executable by a digital processing apparatus to perform operations to identify at least one programmable device by configuration state, the operations comprising: formulating a specification of a state-dependent action to be performed on the at least one programmable electronic device, where the specification comprises a description of an initial state configuration to be possessed by the at least one programmable electronic device; determining at least one element which describes the initial state configuration; creating a software agent to test for the presence of the at least one element which describes the initial state configuration in the at least one programmable electronic device; applying the software agent to the at least one programmable electronic device to test for the presence of the at least one element which describes the initial state configuration; and receiving a result that indicates the presence or absence of the at least one element which describes the initial state configuration.

A third alternate embodiment comprises a computer system for identifying at least one programmable electronic device by configuration state, where the at least one programmable electronic device has an interface accessible by the computer system, the computer system comprising: at least one memory to store at least one program of machine-readable instructions, where the at least one program performs operations to identify at least one programmable electronic device by configuration state; a computer system interface for connecting to the interface of the programmable electronic device; at least one processor coupled to the at least one memory and the computer system interface, where the at least one processor performs at least the following operations when the at least one program is executed: formulating a specification of a state-dependent action to be performed on the at least one programmable electronic device, where the specification comprises a description of an initial state configuration to be possessed by the at least one programmable electronic device; determining at least one element which describes the initial state configuration; creating a software agent to test for the presence of the at least one element which describes the initial state configuration in the at least one programmable electronic device; applying the software agent to the at least one programmable electronic device to test for the presence of the at least one element which describes the initial state configuration; and receiving a result that indicates the presence or absence of the at least one element which describes the initial state configuration.

Thus it is seen that embodiments of the present invention overcome the limitations of the prior art. In particular, in the prior art there is no known way to accurately identify computer systems in a target population that should receive particular maintenance actions. In prior art scheduling methods that are inventory-based, situations are frequently encountered where the current configuration of a computer system differs from that recorded in the inventory. Since the maintenance activities were scheduled expecting all targeted computers to have a particular configuration, those computers having configurations differing from the recorded configuration cannot receive the scheduled maintenance, and will require maintenance in an additional, remedial, and inefficient maintenance step.

In contrast, methods and apparatus of the present invention form a signature of each computer, each signature specific to a management action to be performed. Computers with like signatures are said to form a group. The precise form a management action takes depends on the common configuration of the computers in the group. The invention consists of automatic and semi-automatic means to determine how to form a signature, given knowledge of the general form of management action to be performed.

Management actions typically transform the state of a computer in a specific way. They require that the state of the computer be acted upon be initially in a subset of the space of all possible states. If they are, the management action is implemented in a manner so as to transform the initial state into another subset of the overall state space can be acted upon by a common management action.

The methods and apparatus of the present invention analyze the transformation of state caused by a specific implementation of a management action and determine which configurations lay within the initial subset. It then characterizes this subset. The signature of a computer with respect to the implementation of a given management action is determined by an analysis of the state of that computer, and whether it lies within the initial subset. For example, if a given management action is intended to provide a security update to the Microsoft Office Suite, the relevant subset of the computer state concerns what components and what versions of the Microsoft Office Suite are installed. If the update is also dependent on the operating system, then the subset also includes the version and service level of the operating system. Thus the invention consists of determining the initial state subset for a particular implementation of a management action and automatically generating a program, or agent, to be run on each computer. That program determines whether that computer's state lies within the initial subset.

Once the agent is constructed, the agent is distributed to and run on all computers to determine whether each computer has a state in the requisite state subset. The results are grouped according to the results of the agent determination. Members of the group running Windows 95 and Office 97, for example, would be determined to be in a state lying within the initial subset for a given management action implementation. That implementation would then be distributed to each computer in the group. Members of the group running Windows XP and Office 2003 will have the management action implemented in a different way.

Thus, in methods and apparatus of the present invention, maintenance actions are scheduled based both on a starting configuration known to exist in a target computer system population and the desired configuration to be achieved after the maintenance actions are performed. Then, an agent constructed with this information in mind, identifies all computers having the target beginning configuration and performs the selected maintenance actions on all computers having the target beginning configuration. When maintenance actions are performed in this manner, taking into consideration all configurations likely to exist in a target computer population, the need for remedial maintenance actions to maintain “irregular” computers can be greatly reduced or even eliminated.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a system in which methods and apparatus acting in accordance with the present invention can be applied;

FIG. 2 depicts a Venn diagram useful for understanding methods acting in accordance with the present invention;

FIG. 3 depicts a typical XML state descriptor in accordance with the present invention;

FIG. 4 depicts the customization of an agent in accordance with the present invention; and

FIG. 5 depicts a system in which methods and apparatus of the present invention have been applied.

### DETAILED DESCRIPTION OF THE PREFERRED EMBODIMENTS

The methods and apparatus of the present invention are applicable not only to computer systems (such as, for example desktop computers, notebook computers and workstations), but also to any programmable electronic device. As used herein “programmable electronic device” encompasses desktop computers, notebook computers, workstations, handheld programmable devices, personal digital assistants, portable multimedia players and any other programmable electronic device requiring maintenance and/or programming updates. The following description of the invention will refer to computers, but those skilled in the art will appreciate that the methods and apparatus of the present invention can be applied to any programmable electronic device.

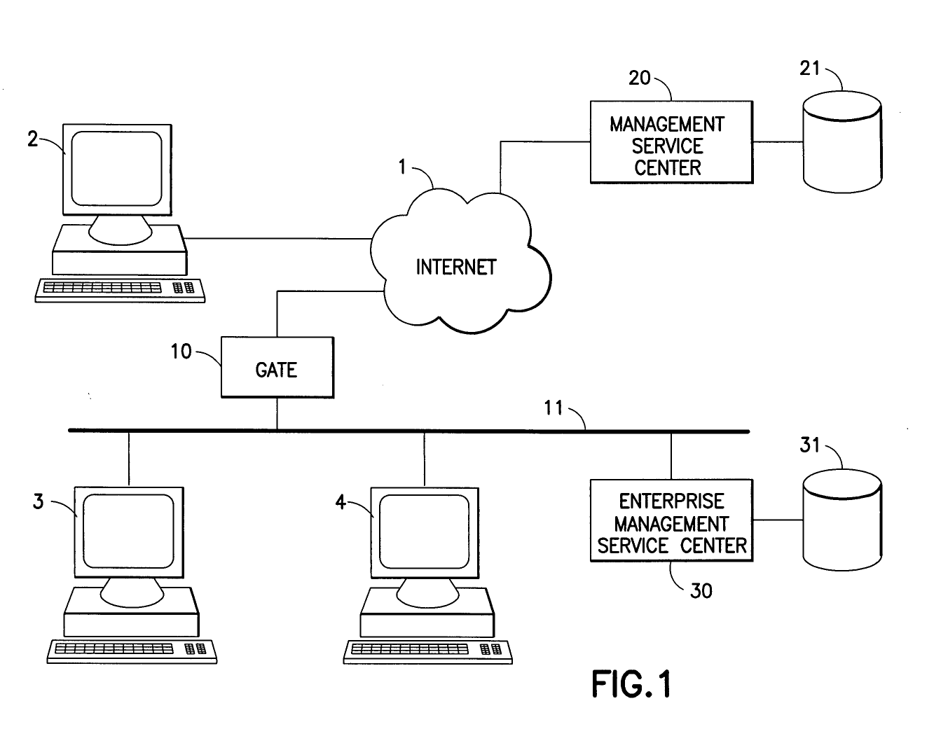

FIG. 1 illustrates the overall configuration of a system in which the invention is useful. The figure shows client personal computers 2, 3 and 4 which are the computers on which management actions will be performed. Client personal computer 2 is attached to the internet 1 by means not shown, while client personal computers 3 and 4 are attached to a local area network 11. Computers attached to local area network 11 can communicate with each other directly, and by communicating with gateway 10, can communicate to and through the internet. Also shown in the figure are two management service centers 20 and 30, each with local persistent storage 21 and 31, respectively. Management service center 20 is attached to the internet 1 through means not shown, while management service center 30 is attached to local area network 11. Management service center 20 is typical of a service center capable of providing management services to any internet-connected computer, including client personal computers 3 and 4, while management service center 30 is typical of a service maintained by and providing services to an enterprise.

In operation, the invention resides in management service centers 20 or 30, or both. Personnel or automated processes in management service centers 20 and 30 become aware of maintenance actions that must be performed on one or more of client personal computers 2, 3 and 4. The invention concerns means by which management service centers 20 and 30 construct to discover groups of client personal computers 2, 3 and 4 such that a common implementation of a management action can be applied to all members of a group.

Management actions need not me limited to maintenance actions, such as modification to security applications. For example, actions may include one or more of the following: the determination of proactive maintenance schedules based on predicted hardware of software failures (for example, if a user's operating system and particular applications are extremely out of date, a maintenance schedule may include a greater or lesser frequency of scans for relevant, available updates); decisions regarding efficient client lifecycle management (for example, if a machine's operating system is extremely out of date, a decision may be made to replace the user's hardware); the likelihood of malicious activity in a group (for example, if a group is running Linux, the likelihood of malicious activity might be less than for running other operating systems); decisions that facilitate transfer or sale of assets when a company merges with another or divests operations; when one group in an organization splits or merges with another (for example, if users have certain operating systems and applications on their machine, the value of these assets may be determined in an efficient manner); and the determination of inefficient use of devices in a group or among groups (for example, if users in a group are all using old software, they may be inefficient, and a corporation may wish to educate members of this group.)

The application of actions may take place in a peer-to-peer arrangement to great advantage. For example, once an action is determined for one member of a group, this member may transmit the action to another member in the group. In one embodiment operating in accordance with the present invention, once a member of a group downloads a software update, or receives a pushed update from a central server machine, this member may update other members of the group with this software update. This approach has an advantage because it offloads computational and network bandwidth pressure from a central maintenance machine. The group member cannot make an error in sending the update to another co-member in a group because members of a group will have the same signature.

The methods and apparatus of the present invention can also be implemented as a service provided to third parties by a service provider. In such situations, the level of configuration state identification activities performed by the service provider would be metered and a bill would be generated in dependence on the metered level of activity.

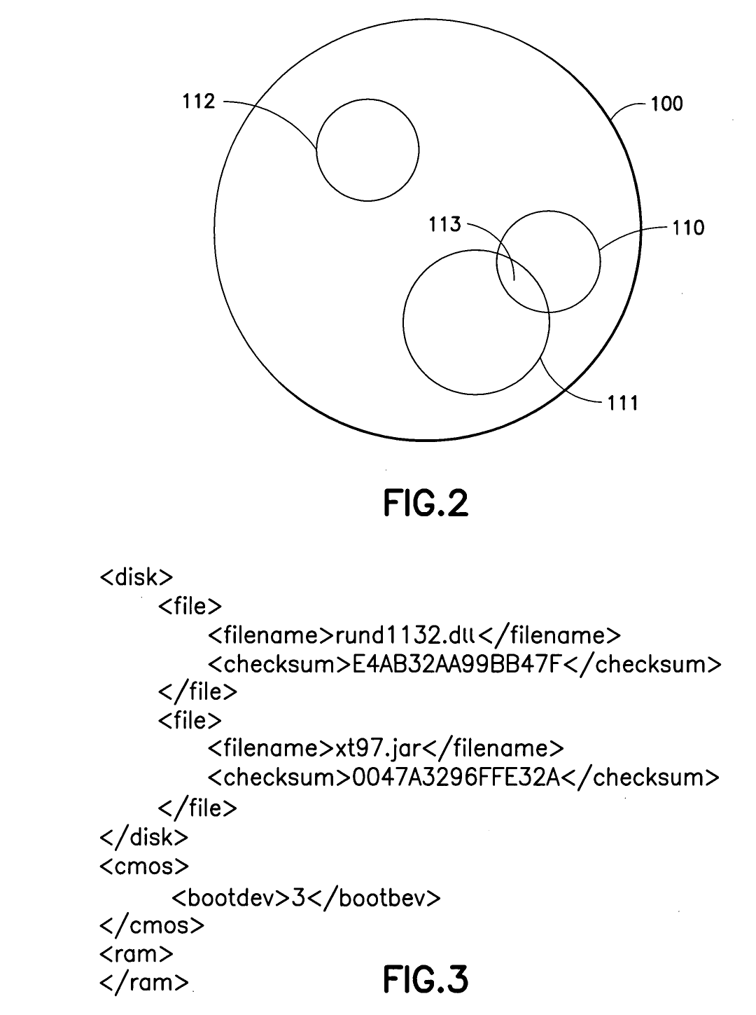

FIG. 2 illustrates the concept of state space 100. The state space of a computer is a conceptual space in which each point represents a vector of actual values for the storage elements of the computer. For example, the storage elements of a typical computer include the contents of its BIOS memory, the contents of its CMOS NVRAM memory, the contents of its DRAM memory and the state of each bit stored on its attached storage devices (hard disks and the like). These vectors are very long. If the length of a vector is N, the size of the state space is 2^{N}. Also shown in the figure are three subsets of the state space 110, 111 and 112. Although these subsets are drawn as closed geometric figures, this does not imply that the states contained in a subset are proximate in any sense. For purposes of illustration, suppose that subset 110 represents a set of states such that a given management action implementation would be appropriate to apply to the computer if and only if the computer's 10 current state were in subset 110. Similarly, M2 and M3 would be appropriate to apply to the computer if and only if the computer's current state was in subset 110. Similarly, M2 and M3 would be appropriate to apply to the computer if and only if the computer's current state were in subsets 111 and 112, respectively. Note that if the computer's current state were in overlap region 113 of the state space 100, either M1 or M2 could be profitably applied.

Typically a state space subset such as subset 112 of FIG. 2 is defined by certain elements of the state vector as being of no concern. That is, it is often the case that a management action implementation would succeed independent of the current contents of the computer's DRAM memory. Thus it is unnecessary to test any element of the current contents of the computer's DRAM memory in order to determine whether a given management action implementation is appropriate. This is fortunate, because such testing, were it exhaustive, would take a prohibitive amount of time.

It will now be described how it is possible to examine the implementation of a particular management action to determine the subset of computer states appropriate for it. That is, if a computer's current state is in the subset, then the management action implementation is appropriate and will succeed. But first, it will be instructive to consider an example, that of a computer running Microsoft Windows 95 and Microsoft Office 97, wherein the vendor of such software has determined that there is an unfavorable interaction between Windows 95 and Office 97 and recommends a patch to both Windows 95 and Office 97 to remediate this unfavorable interaction. The means of patching depends on facilities present only in Windows 95, and is a Windows executable (.exe) file. In our terminology, this file, when executed by the computer, is an implementation of a management action.

The state space subset appropriate to this implementation first consists of the presence of Windows 95, which may be represented in FIG. 2 as subset 110. Tests may be performed on the current state of a given computer to see if that state is in subset 110. One test is to execute a system call of a certain kind, whose results will indicate the version and kind of the operating system currently running on the computer. This test is much simpler than evaluating the entire state vector and comparing it with the subset definition. But this is not sufficient to determine whether the subject implementation of the management action (the .exe file) can run successfully. It is also necessary to determine whether Microsoft Office 97 is currently installed. The state space subset indicative of this condition is subset 111 of FIG. 1.

The test here is performed by sampling a very small set of elements in the current state vector, those elements indicative of the presence of certain files in the file system of the computer. This is a means commonly employed to discover the presence of an installed application on a given computer, for example by the IBM Director program, a product of the IBM Corp. of Armonk, N.Y. If this test succeeds, it is likely (although not proven) the the current state of the computer system is in subset 111 of FIG. 1. If this and the previously described test both succeed, the current state of the computer is in both subsets 110 and 111, or in overlap area 113 of FIG. 1. This subset of the state space 100 is indicative of the appropriateness and probable success of the implementation of the subject management action.

Thus by the foregoing discussion it has been indicated how, through a few simple tests, the current state of a computer system can be classified as belonging to, or not belonging to, a specific subset of the state space appropriate to and indicative of the probable success of a specific management action implementation.

The first step in the automatic construction of an agent is to obtain and execute the specific management action implementation on a computer equipped to record which components of that computer's state are examined by the implementation. Modern computers contain a facility known as a debugging support facility. For example, processors made by the Intel Corp. of Santa Clara, Calif. according to the IA-32 Intel Architecture contain such a facility. It is well known in the art to exploit such a facility to obtain a trace, or record, of the RAM memory locations examined by running a program. Similarly, modern computer operating systems, such as the Microsoft Windows operating system, contain facilities permitting the insertion of monitoring programs so as to record a trace, or record, of the hard disk locations examined by running a program. Thus the execution of the management action implementation on this computer, so equipped and configured, can result in a trace of both RAM accesses and hard disk accesses. This trace reflects the computer state space on which the management action implementation depends.

This trace represents a worst case, in that it contains computer state on which the management action implementation depends, but may also contain computer state that is not relevant to correct functioning of the management action implementation. Knowledge of the implementation of the management action can be used to reduce the amount of state to that which is relevant, so as to optimize this state determination. Regardless of whether the process of state determination is optimized, it is the case that the correct functioning of the management action implementation does not depend on any part of the computer's state space other than the state space determined by the above-described process.

It now remains to determine what specific settings for state in the relevant state space constitute necessary and sufficient conditions for the successful execution of a given management action implementation. If the state space is small this can be accomplished by executing the management action implementation with all possible values of state, noting for which values the execution is successful, comparing the values for which execution is successful and eliminating members of the state space that do not determine successful execution. The remaining members of the state space and their values constitute a test set that is desired. In the case that the state space is large this means of test set determination may be impractical. Again, specific knowledge of the implementation of the management action can be used to significant effect to reduce the effort necessary to determine the test set.

It is to be noted that the description given so far concerns unstructured state: that is, state given as a binary vector. In practice, certain components of state relate to other components of state. For example, the file system of a computer, typically provided by the computer's operating system, maintains indices and metadata about files residing on the computer's hard disk. If the structure of the computer system's state is known, significant simplifications of the process that determines the test set can be achieved.

This specific knowledge of the implementation of the management action is seen to be valuable in many cases, as it may make the difference between a practical determination of the test set and a lengthy and costly determination of the test set. It is desired to shorten the time and reduce the cost of the determination the test set, so as to shorten the time to apply the management action.

Particularly in the case of management actions that fix security vulnerabilities, the time to fix these vulnerabilities is of paramount concern. Accordingly, the subject invention provides descriptive means by which the implementers of a management action can indicate which components of computer state are relevant to the correct functioning of a given implementation of that management action.

FIG. 3 shows a fragment of an XML document descriptive of relevant computer state. XML is a textual document representation of uniquely flexible capabilities, described, for example, in the book “XML in a Nutshell,” by Elliotte Rusty Harold and W. Scott Means, O'Reilly publisher. The XML document is intended to be prepared by an implementer of a management action based on knowledge of that implementation, and is used to prepare the test set. FIG. 3 describes computer system state, by listing two files of given name with given checksums, and a partial contents of the computer's non-volative CMOS memory. FIG. 3 describes computer system state in a structured manner: that is, by listing a named component of the state of the computer's non-volative CMOS memory, or by giving the checksum of a named file.

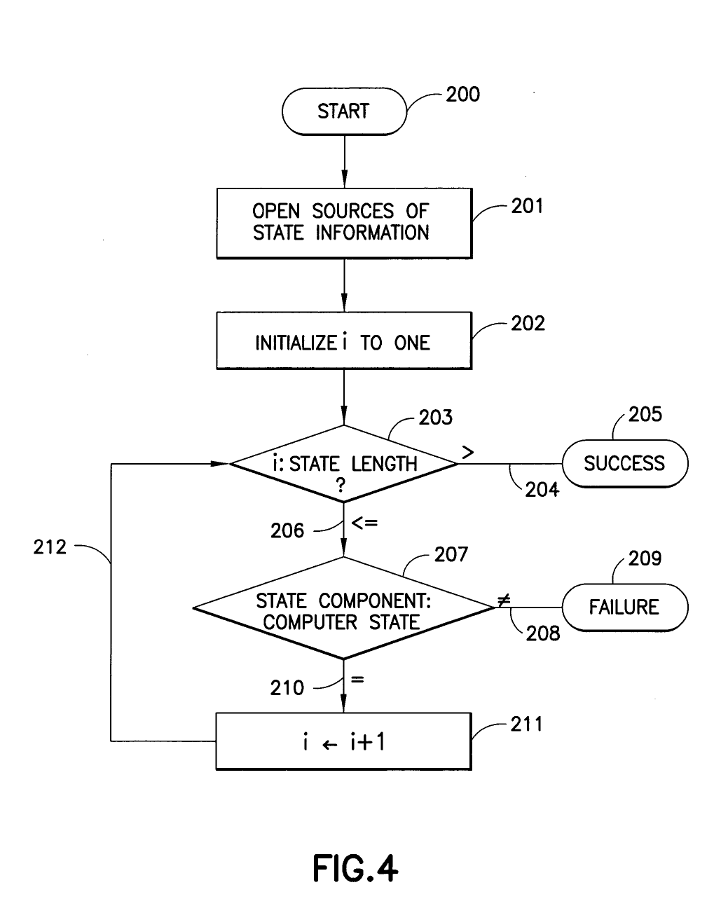

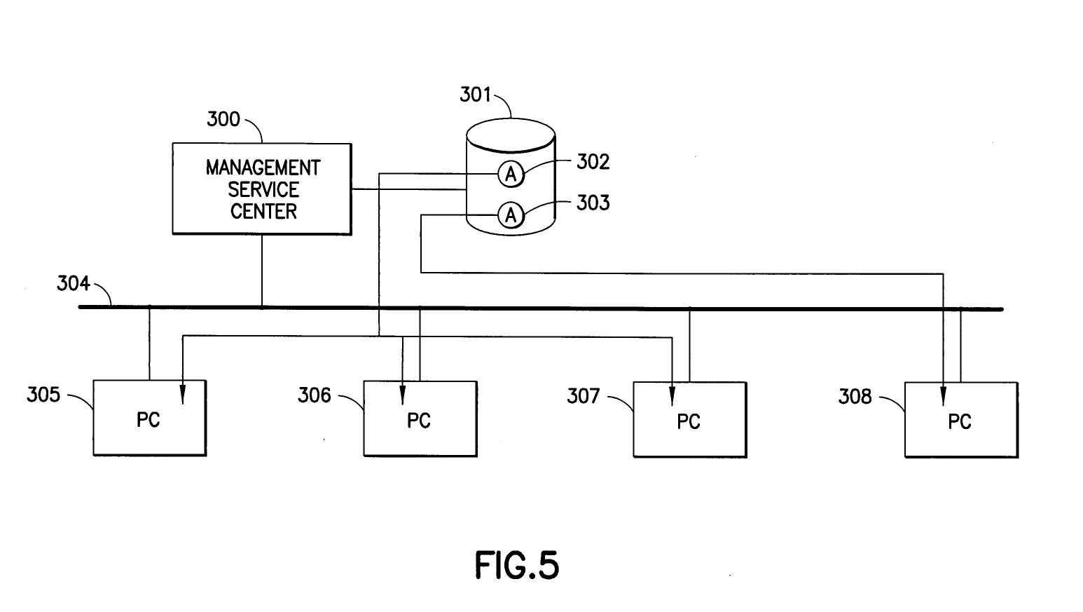

FIG. 4 shows the processing performed by an agent. All agents perform the same processing, customized to the specific management action implementation by different state information (the test set). In block 200 processing begins. Block 201 opens the test set, be it state vectors for given state subspaces, or XML documents as depicted in FIG. 3. Block 201 gains access to this information as an ordered sequence of state components. Block 202 then initializes an index variable i to one. This variable will control a subsequent loop, which tests state components against the actual state of the computer.

Block 203 tests to see if the index variable i exceeds the number of state components to be tested. If so, branch 204 is taken to terminal 205, indicating success, in that all state components match their corresponding components of computer state. If not, branch 206 is taken to comparison block 207, which compares the i-th component of the test set to the corresponding component of computer state. If they match, branch 210 is taken to block 211, where the loop index is incremented. Following block 211, branch 212 is taken to comparison block 203. If, however, the i-th component of the test set does not match the corresponding component of the computer state, branch 208 is taken to terminal block 209, indicative of failure. Terminal blocks 205 and 209 would preferably contain software that communicates success or failure, respectively, to a collection point.

It has been seen how an agent program can be constructed automatically to test whether a management action implementation will succeed. It remains to be described how the grouping of candidate computers is performed, such that computers in a group may execute a given management action implementation successfully.

FIG. 5 shows the general disposition of system components wherein grouping is performed. Management service center 300 is a server computer whose function is to prepare and distribute grouping agents 302 and 303 from storage device 301 to managed personal computers 305, 306, 307 and 308 using computer network 304. In the figure are shown two agents 302 and 303, each agent particular to a different implementation of the same management action. Through means not shown, management service center 300 determines that agent 302 is to be distributed to personal computers 305, 306 and 307, while agent 303 is to be distributed to personal computer 308. This decision may be made, for example, on the basis that personal computers 305, 306 and 307 run the Windows operating system, while personal computer 308 runs the Linux operating system. In operation, agents run in personal computers 305, 306, 307 and 308 and report back success or failure to management service center 300. If the agent in personal computer 307 reports back failure, while those in personal computers 305 and 306 report back success, a group consisting of personal computers 305 and 306 is thereby formed, such that members of that group can run the given management action implementation successfully. The management service center 300 would distribute that management action implementation to all members of the group.

A second group is also formed consisting of personal computer 307, known not to be capable of running the given management action implementation. The management service center will not distribute the given management action implementation to personal computer 307, because it would be a waste of time and resources. Rather, the management service center would obtain, through means not shown, an alternate implementation of the management action, create an agent for that alternate implementation, distribute that agent to personal computer 307, and if the agent is successful, would distribute the alternate implementation of the management action to person computer 307.

Many forms of this invention are possible. The sites at which management actions are performed may be server computers, computer-based appliances or any other devices capable of running programs. The network over which agents and management action implementations are distributed may be wired or wireless. The management service center may be a single computer, a complex of computers or a virtual computer consisting of a temporary assembly of other computers, as in peer networking. The actions performed are not limited to management actions but may be any computer program. For example, if it is desired to distribute a computer program to many computers for a massively parallel computation, such as SETI@ home, hosted from the University of California at Berkeley, the invention can be applied to determine which group of computers will run the program successfully.

Thus it is seen that the foregoing description has provided by way of exemplary and non-limiting examples a full and informative description of the best method and apparatus presently contemplated by the inventors for categorizing computer system states for use in identifying individual computer systems to receive state-dependent maintenance. One skilled in the art will appreciate that the various embodiments described herein can be practiced individually; in combination with one or more other embodiments described herein; or in combination with computer systems differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

We claim:

1. A method for identifying at least one programmable electronic device by configuration state, the method comprising:
formulating a specification of a state-dependent action to be performed on the at least one programmable electronic device, where the specification comprises a description of an initial state configuration to be possessed by the at least one programmable electronic device;
determining at least one element which describes the initial state configuration;
creating a software agent to test for the presence of the at least one element which describes the initial state configuration in the at least one programmable electronic device;
applying the software agent to the at least one programmable electronic device to test for the presence of the at least one element which describes the initial state configuration; and
receiving a result that indicates the presence or absence of the at least one element which describes the initial state configuration.

2. The method of claim 1 where the at least one programmable electronic device comprises a plurality of programmable electronic devices, and where the method further comprises:
identifying a group of programmable electronic devices which share the at least one element which describes the initial state configuration.

3. The method of claim 2 further comprising:
applying the state-dependent action to the group of programmable electronic devices.

4. The method of claim 1 where the at least one programmable electronic device comprises a computer system.

5. The method of claim 1 where the specification further comprises a description of a desired end state configuration to be possessed by the at least one programmable electronic device after the state-dependent action is applied to the at least one programmable electronic device; where the at least one element comprises at least two elements, where at least one of the at least two elements describes the desired end-state configuration to be possessed by the at least one programmable electronic device after the state-dependent action is applied; and where the software agent also tests the programmable electronic device to determine whether the at least one element which describes the desired end-state configuration will be possessed by the at least one programmable electronic device after the state-dependent action is applied to the programmable electronic device.

6. The method of claim 1 where the initial state configuration concerns an operating system installed in the programmable electronic device.

7. The method of claim 1 where the initial state configuration concerns an application program installed in the programmable electronic device.

8. The method of claim 1 where the initial state configuration concerns a driver installed in the programmable electronic device.

9. The method of claim 1 where the action comprises a maintenance activity.

10. The method of claim 1 where the action comprises a modification of at least one of an operating system installed in the programmable electronic device; an application program installed in the programmable electronic device; a security application installed in the programmable electronic device; and a driver installed in the programmable electronic device.

11. The method of claim 1 where the action comprises at least one of: the determination of proactive maintenance schedules based on predicted hardware of software; decisions regarding efficient client lifecycle management; the likelihood of malicious activity in a group; decisions to facilitate transfer or sale of assets when a company merges with another or divests operations; decisions regarding assets when a department with an organization splits or merges with another department; and facilitation and determination of inefficient use of devices in a group or among groups.

12. The method of claim 1 in which the action is applied by one peer to another in apeer-to-peer environment.

13. The method of claim 1, where the method is performed as part of a service provided to at least one third party by a service provider.

14. The method of claim 13, where the at least one programmable electronic device comprises a plurality of electronic devices, and where the method further comprises:
metering a level of configuration state identification activities performed on the plurality of electronic devices of the at least one third party; and
generating a bill in dependence on the metered level of configuration state identification activities.

15. A signal-bearing medium tangibly embodying a program of machine-readable instructions executable by a digital processing apparatus to perform operations to identify at least one programmable device by configuration state, the operations comprising:
formulating a specification of a state-dependent action to be performed on the at least one programmable electronic device, where the specification comprises a description of an initial state configuration to be possessed by the at least one programmable electronic device;
determining at least one element which describes the initial state configuration;
creating a software agent to test for the presence of the at least one element which describes the initial state configuration in the at least one programmable electronic device;
applying the software agent to the at least one programmable electronic device to test for the presence of the at least one element which describes the initial state configuration; and
receiving a result that indicates the presence or absence of the at least one element which describes the initial state configuration.

16. A computer system for identifying at least one programmable electronic device by configuration state, where the at least one programmable electronic device has an interface accessible by the computer system, the computer system comprising:
at least one memory to store at least one program of machine-readable instructions, where the at least one program performs operations to identity at least one programmable electronic device by configuration state;
a computer system interface for connecting to the interface of the programmable electronic device; and
at least one processor coupled to the at least one memory and the computer system interface, where the at least one processor performs at least the following operations when the at least one program is executed:
formulating a specification of a state-dependent action to be performed on the at least one programmable electronic device, where the specification comprises a description of an initial state configuration to be possessed by the at least one programmable electronic device;
determining at least one element which describes the initial state configuration;
creating a software agent to test for the presence of the at least one element which describes the initial state configuration in the at least one programmable electronic device;
applying the software agent to the at least one programmable electronic device to test for the presence of the at least one element which describes the initial state configuration; and
receiving a result that indicates the presence or absence of the at least one element which describes the initial state configuration.

17. The computer system of claim 16 where the computer system further comprises a network, whereby the software agent is applied to the at least one programmable electronic device over the network.

18. The computer system of claim 16 where the specification further comprises a description of a desired end state configuration to be possessed by the at least one programmable electronic device after the state-dependent action is applied to the at least one programmable electronic device; where the at least one element comprises at least two elements, where at least one of the at least two elements describes the desired end-state configuration to be possessed by the at least one programmable electronic device after the state-dependent action is applied; and where the software agent also tests the programmable electronic device to determine whether the at least one element which describes the desired end-state configuration will be possessed by the at least one programmable electronic device after the state-dependent action is applied to the programmable electronic device.

19. The computer system of claim 16 where the at least one programmable electronic device comprises a plurality of programmable electronic devices, and where the operations further comprise:
identifying a group of programmable electronic devices which share the at least one element which describes the initial state configuration.

20. The computer system of claim 19 where the operations further comprise:
applying the state-dependent action to the group of programmable electronic devices.
